(19) United States
(12) Patent Application Publication
(10) Pub. No.: US 2005/0033996 A1
(43) Pub. Date: Feb. 10, 2005

(54) Method and apparatus for a communication hub

(76) Inventors: Piau Fong, Gelugor (MY); Siow San Quek, Batu Pahat (MY); Su Ian Yeoh, Sungai Petani (MY); Chee Kiang Yew, Singapore (SG)

Correspondence Address: LAWRENCE N. GINSBERG, 21 SAN ANTONIO, NEWPORT BEACH, CA, 92660-9112, US

(21) Appl. No.: 10/412,707

(22) Filed: Apr. 11, 2003

(30) Foreign Application Priority Data
Nov. 15, 2002 (MY) PI 2002 4280

(51) Int. Cl. G06F 1/26

(52) U.S. Cl. 713/300

(57) ABSTRACT

A communications hub (100) includes a power management unit (110) coupled to a rechargeable battery (130). When non-removable devices (115 and 120) and removable devices are coupled to downstream ports (115A, 120A, 125A and 127A) require low power, the power management unit (110) supplies the required power and charges the rechargeable battery (130) with power from a host computer (160). When a device at one of the downstream ports (115A, 120A, 125A and 127A) requires higher power for operation at a higher data transfer rate, the power management unit (110) detects this requirement, and delivers power from the rechargeable battery (130) to the corresponding downstream port for the device. The communications hub (100) advantageously supplies higher power to the downstream ports (115A, 120A, 125A and 127A), when required, without the need for an external power supply.

### FIELD OF THE INVENTION

The present invention relates to a communications hub and more particularly a communications hub for data and power.

### BACKGROUND OF THE INVENTION

The universal serial bus (USB) is a known serial communications standard for coupling computers, computer accessories and various portable devices, such as personal digital assistants, digital cameras and digital video equipment. The USB standard provides for both, a data link between a host computer and other USB compliant devices; and the supply of power from the host computer to the devices connected thereto. Typically, the host computer has at least one or two downstream ports, where downstream is defined as the direction of data flow from the host or away from the host computer, to which USB compliant devices can be connected via USB connectors.

With the growing popularity of USB devices, a need for a greater number of downstream USB ports has developed. This is because when devices are attached to the one or two available USB ports on a host computer, a user is unable to plug any additional devices to the host.

One solution that is widely available is a USB hub. This is a device that comprises: one upstream port, comprising a male USB connector that couples to a female USB connector of a downstream port on the host computer; and several, typically 2 or more, downstream ports, each provided via a female USB connector.

The USB standard supports data communication and also provides power to devices coupled to downstream ports. A USB hub attached to a host computer can draw a maximum of 500 milliamps (mA) or less from the host computer, and can provide 100 mA or less via each of its downstream ports. Devices that require 100 mA or less are referred to as low power devices, and devices that require more than 100 mA are referred to as high power devices. Examples of low power devices are mice, keyboards and joysticks, and examples of high power devices are digital cameras and hubs.

In addition, devices that are USB version 1.1 compliant have data transfer rates of up to 12 megabits per second, however more recent devices that are USB 2.0 compliant are capable of higher data rates of up to 480 megabits per second. Typically, devices that are USB 2.0 are also USB 1.1 compliant. However, when a device operates at the higher data transfer rate of USB 2.0, it requires more power. In particular, more power is required when the data is being transferred at the higher rate, and at other times, the device operates at a lower power. Typically, when a USB 2.0 device is not supplied with the higher power required for operation at the higher data rate, the device operates at the lower data rate of USB 1.1.

There are broadly two types of USB hubs of interest, bus-powered hubs that operate exclusively on power provided by the host computer via its downstream port; and self-powered hubs, that have their own power supply units that need to be plugged into a mains power supply point.

A disadvantage of a bus-powered hub is that each of its downstream ports can only supply a maximum of 100 milliamps (mA), which is sufficient to power one low power device. Consequently, bus-powered hubs cannot be used when a user needs to operate a high power device, even if a user needs to use the high power device for a relatively short period of time, such as when a USB 2.0 device needs to operate at the higher data rate. Hence, a bus powered hub is unable to supply the higher power required, and therefore cannot support the higher data transfer rate of USB 2.0 devices.

In contrast, a self-powered hub can support the higher power requirements of USB 2.0 devices, however a disadvantage of the self-powered hub is that its power supply unit must be available, and in addition, there must be access to a mains power supply point to which to plug the power supply unit. Consequently, a self-powered hub is not able to support operation of USB 2.0 device at the higher date transfer rates away from a mains power supply point, and is therefore not portable.

A USB compound devices comprises a USB hub that supports removable and non-removable devices therein, and may be bus-powered or self-powered. However, the USB compound device has the same disadvantages as discussed earlier for bus-powered and self-powered hubs, in relation to supporting the high power required for USB 2.0 devices to operate at the higher data transfer rates.

Hence, there is a need to provide additional USB downstream ports for a host computer that will allow additional USB devices to be connected, and which will support high power requirement of devices, particularly USB 2.0 devices operating at the higher data transfer rate, without the need for a separate power supply unit.

### BRIEF SUMMARY OF THE INVENTION

The present invention seeks to provide a method and apparatus for a communication hub, which overcomes or at least reduces the abovementioned problems of the prior art.

Accordingly, in one aspect, the present invention provides a communications hub comprising:
at least one primary data interface for coupling to at least one primary device, and the at least one primary data interface for receiving power from the at least one primary device;
at least one secondary data interface for coupling to at least one secondary device for providing power thereto, wherein the at least one secondary data interface has a predetermined output power limit;
at least one power port for coupling to a rechargeable power source; and
a power management unit coupled to the at least one primary data interface, the at least one secondary data interface, and the at least one power port, the power management unit for directing power from the at least one primary data interface to the at least one power port to charge the rechargeable power source when the at least one secondary device consumes less power than the output power limit, and the power management unit for directing power from the at least one power port to the at least one secondary data interface to provide power from the rechargeable power source to the at least one secondary device when the at least one secondary device consumes more power than the output power limit.

In another aspect the present invention provides a method for managing power in a communications hub, the method comprising the steps of:
a) providing:
   at least one primary data interface for coupling to at least one primary device, and the at least one primary data interface for receiving power from the at least one primary device;
   at least one secondary data interface for coupling to at least one secondary device for providing power thereto, wherein the at least one secondary data interface has a predetermined output power limit;
   at least one power port for coupling to a rechargeable power source; and
   a power management unit coupled to the at least one primary data interface, the at least one secondary data interface, and the at least one power port, the power management unit;
b) detecting power consumed by the at least one secondary device;
c) comparing the detected power with the output power limit;
d) directing power from the at least one primary data interface to the at least one power port to charge the rechargeable power source when the at least one secondary device consumes less power than the output power limit; and
e) directing power from the at least one power port to the at least one secondary data interface to provide power from the rechargeable power source to the at least one secondary device when the at least one secondary device consumes more power than the output power limit.

In yet another aspect the present invention provides a communications hub comprising:
an input power switch for selectively coupling to at least one of a plurality of power sources;
an output power distributor coupled to the input power switch for receiving power therefrom, and for selectively coupling to at least one of a plurality of devices to provide power thereto; and
a power controller coupled to the input power switch and the output power distributor, the controller for detecting power requirement of the at least one of the plurality of devices, and for switching the at least one of the plurality of power sources to provide at least the detected power requirement to the at least one of the plurality of devices.

### BRIEF DESCRIPTION OF THE DRAWINGS

An embodiment of the present invention will now be more fully described, by way of example, with reference to the drawings of which:

FIG. 1 shows a functional block diagram of a communication hub in accordance with the present invention;

FIG. 2 shows a functional block diagram of a power management unit in the communication hub in FIG. 1; and

FIG. 3 shows a flowchart detailing the operation of the power management unit in FIG. 2.

### DETAIL DESCRIPTION OF THE DRAWINGS

A communications hub in accordance with the present invention includes a power management unit coupled to a rechargeable battery. When devices coupled to downstream ports of the communications hub require low power, the power management unit charges the rechargeable battery with power from a host computer. However, when a device at one of the downstream ports requires higher power for operation at a higher data transfer rate, the power management unit detects this requirement, and delivers power from the rechargeable battery to the corresponding downstream port for the device. The communications hub advantageously stores power from a host computer when high power is not needed, and provides the stored power when a device coupled to the communications hub requires higher power.

In addition, the communications hub includes non-removable devices integrally mounted therein and coupled to some of the downstream ports. This advantageously allows the communications hub to: couple the integrally mounted non-removable devices to a downstream port on the host computer; provide downstream ports for coupling additional devices; and provide higher power to both the non-removable devices and the devices coupled to the other downstream ports.

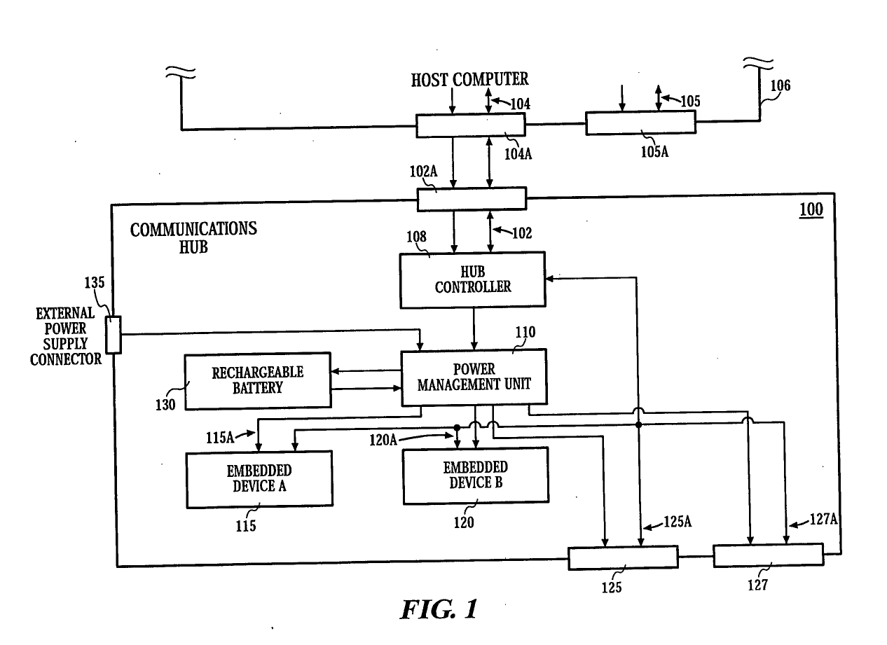

With reference to FIG. 1 a communications hub 100, in accordance with the present invention, has an upstream port 102 that is connected via a male USB connector 102A to a downstream port 104 on a host computer 106, via a female USB connector 104A. As is known, USB upstream and downstream ports 102 and 104 support both data communication and the supply of power. The upstream port 102 provides a primary data interface of the host computer 106, which is a primary device, and the downstream port 104 provides a secondary data interface for coupling to secondary devices.

The host computer 106 can have more than one downstream port, and one other downstream port 105, and its corresponding connector 105A, is shown. As the downstream ports 104 and 105 are root ports of the host computer 106, each of the downstream ports 104 and 105 can provide up to 500 mA. Hence, the communications hub 100 can draw up to 500 mA from the downstream port 104 via the upstream port 102.

The communications hub 100 comprises a hub controller 108 that is coupled to the upstream port 102, coupled to provide power to a power management unit 110, and coupled to support data communications between the host computer 106 and four downstream ports 115A, 120A, 125A and 127A. The hub controller 108 can comprise a hub controller integrated circuit, such as AU9274, manufactured by Alco Micro of Taiwan.

A power management unit 110 is coupled to receive power from the host computer 106 via the hub controller 108, and also coupled to receive power from an external power supply (not shown) via an external power supply connector 135. The power management unit 110 in a preferred embodiment comprises a custom made integrated circuit.

As is known, an external power supply unit for a USB hub requires a mains power supply point to receive AC power therefrom. The external power supply unit has an output connector that provides power, at a predetermined DC voltage and current rating, and the output connector couples to the external power supply connector 135 or power port on the communications hub 100 hub.

Alternatively, the external power supply unit can comprise a portable power source or stored energy source, such as a dry cell battery, which is connected to the external power supply connector 135 on the communications hub 100. The dry cell battery providing power at the predetermined DC voltage and current rating, when coupled via an appropriate connector to the external power supply connector 135.

The power management unit 110 is has an input or power port that is coupled to receive power from a rechargeable power source or stored energy source, such as a rechargeable battery 130. The rechargeable battery 130 can be integrally mounted in the communications hub 100, or can be externally mounted. In addition, the power management unit 110 is also coupled to provide power to recharge the rechargeable battery 130.

Embedded devices A 115 and B 120 are non-removable devices that are coupled to the downstream ports 115A and 120A, respectively. In addition, the downstream ports 125A and 127A are coupled to female USB connectors 125A and 127A, respectively. The downstream ports 125 and 127 are for coupling to additional USB devices (not shown) as required by a user of the host computer 106.

The non-removable devices can are devices integrated within a housing of the communications hub, and can include a variety of wired and wireless devices. Wired devices can comprise a wired communications interface such a Firewire interface, and wireless devices can include a wireless communication interface such as a Bluetooth interface or a wireless local area network (Wi-Fi) interface. The non-removable devices can also include data storage devices, such as magnetic, optical and solid-state data storage devices. In addition, the non-removable interface can comprise a removable storage media interface for compact flash cards, secure digital cards, and multi-media cards.

Hence, the power management unit 110 advantageously receives power from the host computer 106 via the hub controller 108, from the external power supply via the external power supply connector 135, and/or from the rechargeable battery 130. The power management unit 110 is also advantageously coupled to provide power to one or more of the downstream ports 115A, 120A, 125A and 127A, based on the power requirements of devices coupled to the respective downstream ports 115A, 120A, 125A and 127A.

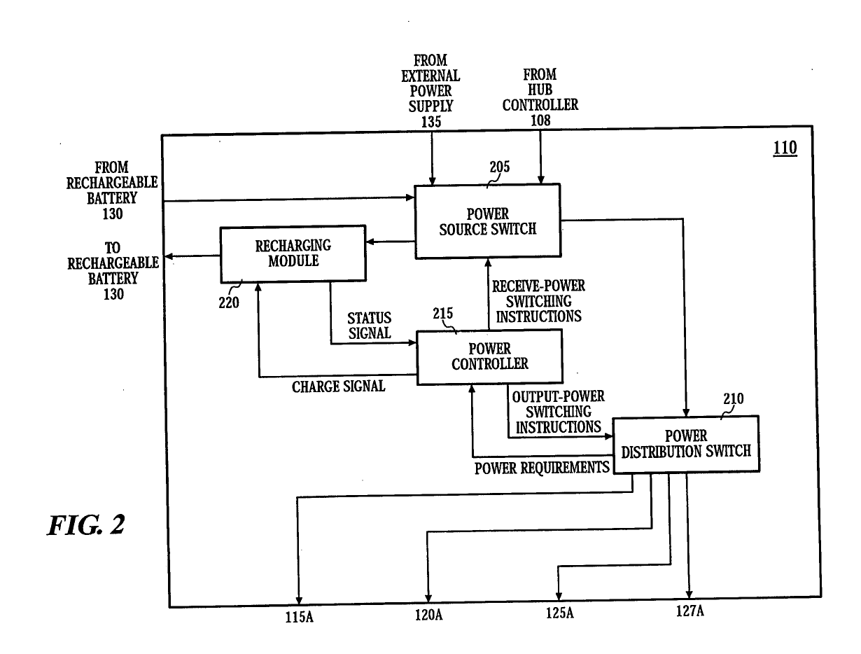

With reference to FIG. 2 the power management unit 110 comprises a power source switch 205 or input power selector, which has an input coupled to receive power from the host computer 106 via the hub controller 108, and another input to receive power from the external power supply, via the external power supply connector 135. In addition, the power source switch 205 is also coupled to receive power from the rechargeable battery 130, and has outputs for providing power from these three power sources. The power source switch 205 also has a control input for receiving receive-power switching instructions, and can individually select power to be received from one or more of the three power sources i.e. host power 106, rechargeable battery power 130, or power from an external power supply via connector 135, in accordance with the receive-power switching instructions, and can selectively provide power from the selected power source from one of its outputs.

The power management unit 110 includes a power distribution switch 210 that is coupled to receive power from the outputs of the power source switch 205, and can be selectively coupled to provide power to any one or more of the downstream ports 115A, 120A, 125A and 127A. The power distribution switch 210 also has a control input for receiving output-power switching instructions, and can individually select the downstream ports 115A, 120A, 125A and 127A to which to provide power from the three power sources.

In addition, the power distribution switch 210 detects the particular power requirements of devices that are coupled to the downstream ports 115A, 120A, 125A and 127A, and the power distribution switch 210 has an output that provides an output power detect signal. The output power detect signal indicates the particular power requirements of the particular devices that are coupled to the downstream ports 115A, 120A, 125A and 127A. Detection of power can be achieved by detecting magnitude of current flowing.

The power management unit 110 further comprises a power controller 215 that is coupled to receive the particular power requirements of the devices that are coupled to the downstream ports 115A, 120A, 125A and 127A from the power distribution switch 210. In response, the power controller 215 provides the necessary receive-power switching instructions to the power source switch 205 so that power sources that are required to provide power to meet the requirements of the devices that are coupled to the downstream ports 115A, 120A, 125A and 127A are coupled by the power source switch 205 to the power distribution switch 210. The power controller 215 then provides the appropriate output-power switching instructions to the power distribution switch 210 to switch the received power from the selected power sources to the particular downstream ports 115A, 120A, 125A and 127A for the respective devices coupled thereto.

The power management unit 110 also includes a recharging module 220, which has an input that receives power from the power source switch 205, and the recharging module 220 has an output that provides charging power, typically by way of a charging current, to the rechargeable battery 130. The recharging module 220 also has an output that provides a status signal to the power controller 215 indicating charge status of the rechargeable battery 130, and an input 215 to receive a charge signal from the power controller 215. When the status signal indicates the charge of the rechargeable battery 130 is below a predetermined low level of charge, the power controller 215 switches the charge signal to an ON condition, and when the status signal indicates the charge of the rechargeable battery 130 is higher than a predetermined high level of charge, the power controller 215 switches the charge signal to an OFF condition.

Hence, the power management unit 110 comprises a power source switch 205 that is coupled to receive power from a variety of power sources 108, 130 and 135; a power distribution switch that is coupled to distribute power to a variety of downstream ports 115A, 120A, 125A and 127A; a power controller 215 that detects the power requirements of devices coupled to the variety of downstream ports 115A, 120A, 125A and 127A; and the power controller 215 selectively directs power from the variety of power sources 108, 130 and 135 to the devices at the respective ports 115A, 120A, 125A and 127A, to meet the respective power requirements of the devices. Directing power is performed by switching the flow of current.

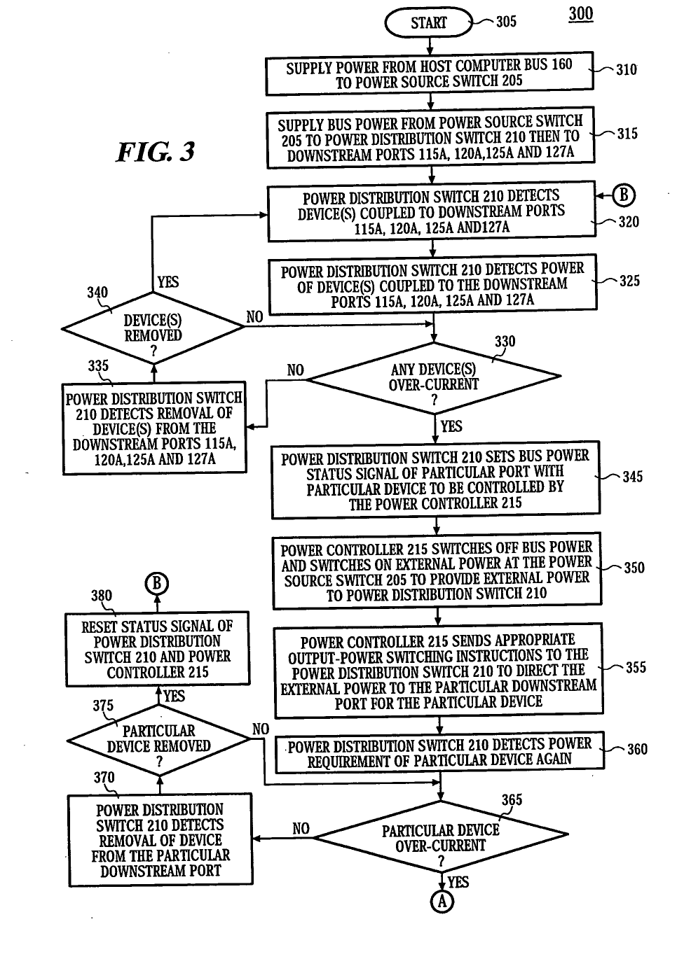

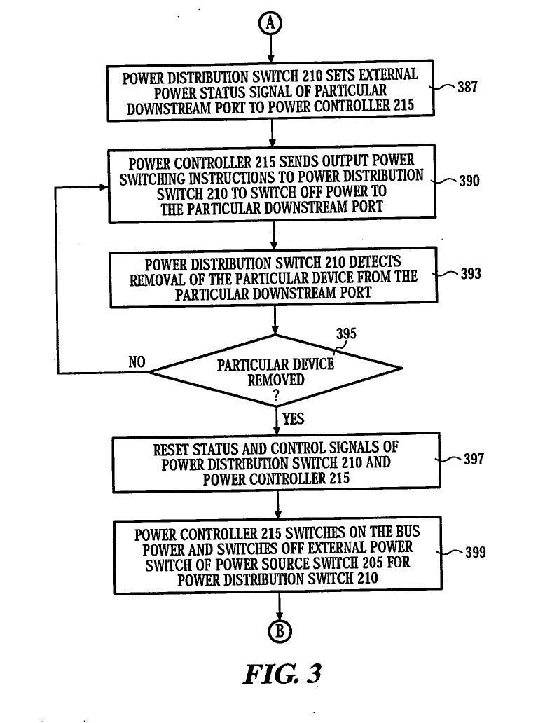

With reference to FIG. 3, the operation 300 of the power management unit 110 starts 305 with the host computer 106 supplying 310 power from its USB bus to the power source switch 205 via the hub controller 108. Power is then supplied 315 from the power source switch 205 to the power distribution switch 210, and from there to the downstream ports 115A, 120A, 125A and 127A.

The power distribution switch 210 then detects 320 devices that are coupled to the downstream ports 115A, 120A, 125A and 127A, and subsequently, the power distribution switch 210 detects 325 the power requirements of devices that are coupled to the downstream ports 115A, 120A, 125A and 127A. A determination 330 is then made as to whether any of the devices is drawing more current i.e. more than 100 mA, which is the output power limit for the downstream ports 115A, 120A, 125A and 127A. This causes an over-current condition.

When none of the devices cause an over-current condition, the power distribution switch 210 detects 335 removal of any of the devices from any of the downstream ports 115A, 120A, 125A and 127A. A further determination 340 is then made whether any of the devices are removed. When a device removal is detected the operation 300 returns to the power distribution switch 210 detecting 320 if any devices are coupled to any of the downstream ports 115A, 120A, 125A and 127A. However, when a device removal is not detected, the operation 300 returns to determining 330 whether any of the downstream ports 115A, 120A, 125A and 127A are causing an over-current condition.

When one of a particular device causes an over-current condition, the power distribution switch 210 sets 345 a bus power status signal of the particular downstream port, having the particular device coupled thereto, indicating the power for the particular downstream port is to be controlled by the power controller 215.

The power controller 215 then sends 350 receive-power switching instructions to the power source switch to switch OFF bus power and switch ON external power to provide external power to the power distribution switch 210. Next, the power controller 215 sends 355 appropriate output-power switching instructions to the power distribution switch 210 to direct the external power to the particular downstream port for the particular device.

It should be noted that here, the external power refers to power from the rechargeable battery 160, as no external power supply is coupled to the external power supply connector 135. However, when the an external power supply unit is employed, reference to external power will then apply to power provided by the external power supply unit. Detection and selection of the availability of power from an external power supply unit will be performed by the controller 215 and the power source switch 205.

The power distribution switch then detects 360 the power requirement of the particular device once again, and then determines 365 whether the particular device causes an over-current condition. When no over-current condition results, the power distribution switch 210 detects 375 removal of the particular device from the particular downstream port. A further determination 375 is then made whether any the particular device has been removed. When removal of the particular device is detected the operation 300 returns to the power distribution switch 210 detecting 365 the over-current condition at the particular downstream port. However, when the particular device is not detected, the status signal of the power distribution switch 210 and the power controller 215 is reset 380, and the operation 300 proceeds to step 320, as described earlier.

When the particular device at the particular downstream port does not result an over-current condition 365, the power distribution switch 210 sets 387 a power status signal of the particular downstream port indicating that the power to the particular downstream port is now controlled by the power controller 215.

Subsequently, the power controller 215 send 390 output-power switching instructions to the power distribution switch 210 to switch OFF power to the particular downstream port, and the power distribution switch then detects 393 removal of the particular device from the particular downstream port.

A determination 395 is then made as to whether the particular device has been removed from the particular port. When it has not been removed, the operation 300 returns to step 390, as was described earlier. Alternatively, when the particular device has been removed from the particular port, the status and control signals of the power distribution switch 210 and the power controller 215 are reset 297.

The power controller 215 then sends 399 receive-power switching instructions to the power source switch 205 to cause the power source switch 205 to switch ON the bus power from the host computer 160, and switch OFF the external power to the power distribution switch 210. The operation 300 then proceeds to step 320 as was previously described.

The communication hub of the present invention as described, advantageously provides additional USB downstream ports for a host computer that will allow additional USB devices to be connected in addition to non-removable devices, and which will support high power requirement of devices, particularly USB 2.0 devices operating at the higher data transfer rate, without the need for a separate power supply unit.

This is accomplished by a power management unit that can selective receive power from the host computer or from the rechargeable battery 130. The power management unit can also selectively provide higher power to one or more of the downstream ports, based on the power requirements of devices coupled to the respective downstream ports, when the power management unit detects that higher power is required.

Thus, the present invention, as described provides a method and apparatus for a communication hub, which overcomes or at least reduces the abovementioned problems of the prior art.

It will be appreciated that although only a particular embodiment of the invention have been described in detail, various modifications and improvements can be made by a person skilled in the art without departing from the scope of the present invention.

1. A communications hub comprising:
at least one primary data interface for coupling to at least one primary device, and the at least one primary data interface for receiving power from the at least one primary device;
at least one secondary data interface for coupling to at least one secondary device for providing power thereto, wherein the at least one secondary data interface has a predetermined output power limit;
at least one power port for coupling to a rechargeable power source; and
a power management unit coupled to the at least one primary data interface, the at least one secondary data interface, and the at least one power port, the power management unit for directing power from the at least one primary data interface to the at least one power port to charge the rechargeable power source when the at least one secondary device consumes less power than the output power limit, and the power management unit for directing power from the at least one power port to the at least one secondary data interface to provide power from the rechargeable power source to the at least one secondary device when the at least one secondary device consumes more power than the output power limit.

2. A communications hub in accordance with claim 1, further comprising at least another power port for coupling to a power supply and the at least another power port being coupled to the power management unit, the power management unit for directing power from the at least another power port to the at least one power port when charging the rechargeable power source with power from the power supply; and the power management unit for directing power from the at least another power port to the at least one secondary data interface when providing power from the power supply to the at least one secondary device.

3. A communications hub in accordance with claim 1 further comprising a communications controller, the communications controller being coupled to the at least one primary data interface, the at least one secondary data interface, and the communications controller for managing communication of data between the at least one primary data interface and the at least one secondary data interface, and the communications controller being coupled to the power management unit for communicating control data therewith.

4. A communications hub in accordance with claim 3, wherein the at least one secondary device comprises an integrated device, physically housed within the communications hub.

5. A communications hub in accordance with claim 4, wherein the integrated device comprises a wired communications interface.

6. A communications hub in accordance with claim 5, wherein the wired communications interface comprises a universal serial bus (USB) interface.

7. A communications hub in accordance with claim 5, wherein the wired communications interface comprises a Firewire interface.

8. A communications hub in accordance with claim 4, wherein the integrated device comprises a wireless communications interface.

9. A communications hub in accordance with claim 8, wherein the wireless communications interface comprises a Bluetooth interface.

10. A communications hub in accordance with claim 8, wherein the wireless communications interface comprises a wireless local area network interface.

11. A communications hub in accordance with claim 4, wherein the integrated device comprises a data storage device.

12. A communications hub in accordance with claim 11, wherein the data storage device comprises a magnetic media data storage device.

13. A communications hub in accordance with claim 11, wherein the data storage device comprises an optical media data storage device.

14. A communications hub in accordance with claim 11, wherein the data storage device comprises a solid-state data storage device.

15. A communications hub in accordance with claim 3, wherein the at least one secondary interface comprises a removable data storage media interface.

16. A communications hub in accordance with claim 15, wherein the removable data storage media interface comprises a compact flash card interface.

17. A communications hub in accordance with claim 15, wherein the removable data storage media interface comprises a secure digital card interface.

18. A communications hub in accordance with claim 15, wherein the removable data storage media interface comprises a multi-media card interface.

19. A communications hub in accordance with claim 3, wherein the at least one primary data interface comprises an upstream universal serial bus (USB) interface.

20. A communications hub in accordance with claim 3, wherein the at least one secondary data interface comprises a downstream USB interface.

21. A communications hub in accordance with claim 3, wherein the communications controller comprises a USB controller.

22. A method for managing power in a communications hub, the method comprising the steps of:
a) providing:
at least one primary data interface for coupling to at least one primary device, and the at least one primary data interface for receiving power from the at least one primary device;
at least one secondary data interface for coupling to at least one secondary device for providing power thereto, wherein the at least one secondary data interface has a predetermined output power limit;
at least one power port for coupling to a rechargeable power source; and
a power management unit coupled to the at least one primary data interface, the at least one secondary data interface, and the at least one power port, the power management unit;
b) detecting power consumed by the at least one secondary device;
c) comparing the detected power with the output power limit;
d) directing power from the at least one primary data interface to the at least one power port to charge the rechargeable power source when the at least one secondary device consumes less power than the output power limit; and
e) directing power from the at least one power port to the at least one secondary data interface to provide power from the rechargeable power source to the at least one secondary device when the at least one secondary device consumes more power than the output power limit.

23. A method in accordance with claim 22 wherein step (b) comprises the step of detecting magnitude of current flowing through the at least one secondary data interface to the at least one secondary device.

24. A method in accordance with claim 23 wherein step (c) comprises the step of comparing the magnitude of current flowing through the at least one secondary interface with magnitude of current associated with the output power limit.

25. A method in accordance with claim 22 wherein step (d) comprises the step of switching current flow from the at least one primary data interface to the at least one power port.

26. A method in accordance with claim 22 wherein step (e) comprises the step of switching current flow from the at least one power port to the at least one secondary data interface.

27. A method in accordance with claim 22 wherein step (a) further comprises the step of providing at least another power port for coupling to a power supply, and the at least another power port being coupled to the power management unit.

28. A method in accordance with claim 27 further comprising the steps of:
aa) directing power from the at least another power port to the at least one power port when charging the rechargeable power source with power from the power supply; and
bb) directing power from the at least another power port to the at least one secondary data interface when providing power from the power supply to the at least one secondary device.

29. A method in accordance with claim 28 wherein step (aa) comprises the step of switching current flow from the at least another power port to the at least one power port.

30. A method in accordance with claim 28 wherein step (bb) comprises the step of switching current flow from the at least another power port to the at least one secondary data interface.

31. A communications hub comprising:
an input power switch for selectively coupling to at least one of a plurality of power sources;
an output power distributor coupled to the input power switch for receiving power therefrom, and for selectively coupling to at least one of a plurality of devices to provide power thereto; and
a power controller coupled to the input power switch and the output power distributor, the controller for detecting power requirement of the at least one of the plurality of devices, and for switching the at least one of the plurality of power sources to provide at least the detected power requirement to the at least one of the plurality of devices.

32. A communications hub in accordance with claim 31 further comprising a data controller having at least one upstream port, wherein the at least one upstream port for coupling to the at least one of the plurality of power sources.

33. A communications hub in accordance with claim 32, wherein the at least one upstream port is suitably adapted for coupling to a host computer, wherein the host computer comprises the at least one of the plurality of power sources.

34. A communications hub in accordance with claim 33, wherein at least one upstream port comprises a USB upstream port.

35. A communications hub in accordance with claim 32, wherein the data controller further comprises at least one downstream port, wherein the at least one downstream port for coupling to the at least one of the plurality of devices.

36. A communications hub in accordance with claim 35, wherein the at least one downstream port is suitably adapted for coupling to any one of a variety of devices.

37. A communications hub in accordance with claim 36, wherein at least one downstream port comprises a USB downstream port.

38. A communications hub in accordance with claim 32, wherein the at least one of the plurality of power sources comprises a stored energy source.

39. A communications hub in accordance with claim 38, wherein the stored energy source comprises a rechargeable battery.

40. A communications hub in accordance with claim 39, further comprising a recharging module coupled to the power controller and to the rechargeable battery, for charging the rechargeable battery.

41. A communications hub in accordance with claim 31, wherein the at least one of the plurality of power sources comprises an external power supply unit.
